(19) United States
(12) Patent Application Publication
(10) Pub. No.: US 2005/0219219 A1
(43) Pub. Date: Oct. 6, 2005

(54) Text data editing apparatus and method

(75) Inventors: Kohei Momosaki, Kanagawa-ken (JP); Hisayoshi Nagae, Kanagawa-ken (JP); Masahide Ariu, Kanagawa-ken (JP); Yasuyuki Masai, Kanagawa-ken (JP); Kazuhiko Abe, Kanagawa-ken (JP); Makoto Yajima, Tokyo (JP); Koichi Yamamoto, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/055,609

(22) Filed: Feb. 11, 2005

(30) Foreign Application Priority Data
Mar. 31, 2004 (JP) 2004-106552

(51) Int. Cl. G09G 5/00

(52) U.S. Cl. 345/169

(57) ABSTRACT

Text data to be displayed on a display area is edited. An obtainment unit inputs the text data. The text data is divided into a plurality of part data each including a linguistic meaning. A selection unit selects at least one part data from the plurality of part data according to a predetermined condition. A size change unit reduces a display size of the text data relative to the display area by editing the at least one part data. An output device having the display area displays the text data in which the at least one part data is edited.

### CROSS-REFERENCE TO RELATED APPLICATIONS

This application is based upon and claims the benefit of priority from prior Japanese Patent Application P2004-106552, filed on Mar. 31, 2004; the entire contents of which are incorporated herein by reference.

### FIELD OF THE INVENTION

The present invention relates to a text data editing apparatus and method for partially editing text data to be displayed on a text data display area.

### BACKGROUND OF THE INVENTION

In a television broadcast and DVD video contents, character data (closed caption) to supplement speech data is provided. The character data of caption is especially effective for not only the hearing impaired but also for someone with normal hearing in the case of hard to hear speech corresponding to an image and in the case of hard to replay the speech as hearable form.

In the television broadcast, character data is provided by embedding a teletext signal on a video signal. Concretely, the character data is transmitted using an identification signal inserted during a vertical blanking interval (VBI signal). In the DVD and so on, caption data of multi-languages can be recorded with the video and speech. Furthermore, in a digital high-vision broadcast, the caption data as subpicture data can be transmitted.

The physical size of a display area to display character data is limited by a size of a television screen. In order to display information on a limited display area for a short time, character data may be scrolled or character data may be switched at predetermined intervals. Especially, in the television broadcast, character data is often displayed in synchronization with the video data.

A scroll display or a switching display of contents by time is used for an information display apparatus having a character display area (one line or a plurality of lines) in addition to the above-mentioned television broadcast. For example, the information display apparatus may be cellular-phone, a display screen of a small-sized information device, an electric bulletin board in the street or the electric car, or a receiver of an FM multiplex telecasting.

The display method in these devices is limited by the size of the display area and the display time. Accordingly, by the scroll display method, text data with many characters can be displayed on the limited area and time.

However, if quantity of character data to be displayed is large, all character data may not be correctly displayed on the limited display area. For example, in the case of displaying all character data on the limited area during the limited time by scrolling, a scroll speed is necessary to be quick. However, if the scroll speed is too quick, a user can not recognize the character data being displayed.

Furthermore, in the switching display method by time, a switching interval is necessary to be short. However, if a period to display one screen of character data is too short, the screen is changed to another screen before a user recognizes the character. Briefly, this display method is hard for the user to recognize the character data.

Furthermore, in a small-sized information device or a personal computer, a scroll display method based on the user's operation is known. However, this is troublesome for the user because the user must operate in order.

On the other hand, Japanese Patent Disclosure (kokai) P2003-122339 is known as another display method. In this method, a display size of image data is adjusted to a display area of the device. Concretely, if the display size of image data is larger than the display area of the device, the display size of image data is uniformly reduced. However, the image data includes both important parts and unimportant part for the user to understand contents of the image data. In spite of this feature, both important parts and unimportant parts are uniformly reduced. As a result, the user can not understand contents of the image data. Thus, this method is also inconvenient for the user to understand the contents.

### SUMMARY OF THE INVENTION

The present invention is directed to a text data editing apparatus and method for effectively displaying text data in order for a user to easily understand contents of the text data.

According to an aspect of the present invention, there is provided an apparatus for editing text data, comprising: an obtainment unit configured to input text data, the text data being divided into a plurality of part data each including a linguistic meaning; a selection unit configured to select at least one part data from the plurality of part data according to a predetermined condition; a size change unit configured to reduce a display size of the text data relative to a display area by editing the at least one part data; and an output device having the display area configured to display the text data in which the at least one part data is edited.

According to another aspect of the present invention, there is also provided a method for editing text data, comprising: inputting text data, the text data being divided into a plurality of part data each including a linguistic meaning; selecting at least one part data from the plurality of part data according to a predetermined condition; reducing a display size of the text data relative to a display area by editing the at least one part data; and displaying the text data in which the at least one part data is edited on the display area.

According to still another aspect of the present invention, there is also provided a computer program product, comprising: a computer readable program code embodied in said product for causing a computer to edit text data, said computer readable program code comprising: a first program code to input text data, the text data being divided into a plurality of part data each including a linguistic meaning; a second program code to select at least one part data from the plurality of part data according to a predetermined condition; a third program code to reduce a display size of the text data relative to a display area by editing the at least one part data; and a fourth program code to display the text data in which the at least one part data is edited on the display area.

### BRIEF DESCRIPTION OF THE DRAWINGS

FIG. 1 is a block diagram of a text data display apparatus 10 according to a first embodiment.

FIG. 2 is a schematic diagram of data component of an importance degree table 108 according to the first embodiment.

FIG. 3 is a flow chart of text data display processing according to the first embodiment.

FIG. 4 is a schematic diagram of part data obtained by a division unit 104 according to the first embodiment.

FIG. 5 is a schematic diagram of an importance degree assigned to each part data according to the first embodiment.

FIG. 6 is a schematic diagram of a display area to display text data in the text data display apparatus according to the first embodiment.

FIG. 7 is a schematic diagram of a reduction ratio of display width of each part data according to the first embodiment.

FIG. 8 is a schematic diagram of part display time of each part data based on the reduction ratio according to the first embodiment.

FIG. 9 is a schematic diagram of a display situation of text data by a display unit 116 according to the first embodiment.

FIG. 10 is a block diagram of hardware component of the text data display apparatus 10 according to the first embodiment.

FIG. 11 is a block diagram of the text data display apparatus 10 according to a modification of the first embodiment.

FIG. 12 is a schematic diagram of another display situation of text data by the display unit 116 according to the modification.

FIG. 13 is a block diagram of a text data display apparatus according to a second embodiment.

FIG. 14 is a block diagram of a text data display apparatus according to a third embodiment.

FIG. 15 is a schematic diagram of one example of display control data stored in a memory unit 300 according to the third embodiment.

FIG. 16 is a schematic diagram of another example of display control data stored in a memory unit 300 according to the third embodiment.

FIG. 17 is a block diagram of a text data display apparatus according to a fourth embodiment.

FIG. 18 is a schematic diagram of one example of information stored in a memory unit according to the fourth embodiment.

FIG. 19 is a schematic diagram of another example of information stored in a memory unit according to the fourth embodiment.

FIG. 20 is a schematic diagram of a display screen 202 and a display area 212 according to a fifth embodiment.

FIG. 21 is a schematic diagram of data component of the importance degree table 108 according to the fifth embodiment.

FIG. 22 is a schematic diagram of text data obtained by a text data obtainment unit 102 according to the fifth embodiment.

FIG. 23 is a schematic diagram of text data displayed on a display area 212 according to the fifth embodiment.

FIG. 24 is a schematic diagram of data component of the importance degree table 108 according to a sixth embodiment.

FIG. 25 is a schematic diagram of one example of text data.

FIG. 26 is a schematic diagram of each pair of words obtained by the division unit 104 and a probability value assigned to each pair according to the sixth embodiment.

FIG. 27 is a schematic diagram of text data displayed on the display area 210 according to the sixth embodiment.

FIG. 28 is a block diagram of a text data display apparatus according to a seventh embodiment.

FIG. 29 is a schematic diagram of a display screen 204 and a display area 214 according to the seventh embodiment.

FIG. 30 is a schematic diagram of part data divided by the division unit 104 according to the seventh embodiment.

FIG. 31 is a schematic diagram of the part data alternately deleted from the text data according to the seventh embodiment.

FIG. 32 is a schematic diagram of display situation of the text data from which the part data is alternately deleted according to the seventh embodiment.

FIG. 33 is a schematic diagram of information stored in a memory according to the seventh embodiment.

FIG. 34 is a block diagram of a text data display apparatus according to an eighth embodiment.

FIG. 35 is a schematic diagram of part data divided by the division unit 104 according to the eighth embodiment.

FIG. 36 is a schematic diagram of text data displayed on the display screen 214 according to the eighth embodiment.

FIG. 37 is a schematic diagram of information stored in a memory according to the eighth embodiment.

### DETAILED DESCRIPTION OF THE EMBODIMENTS

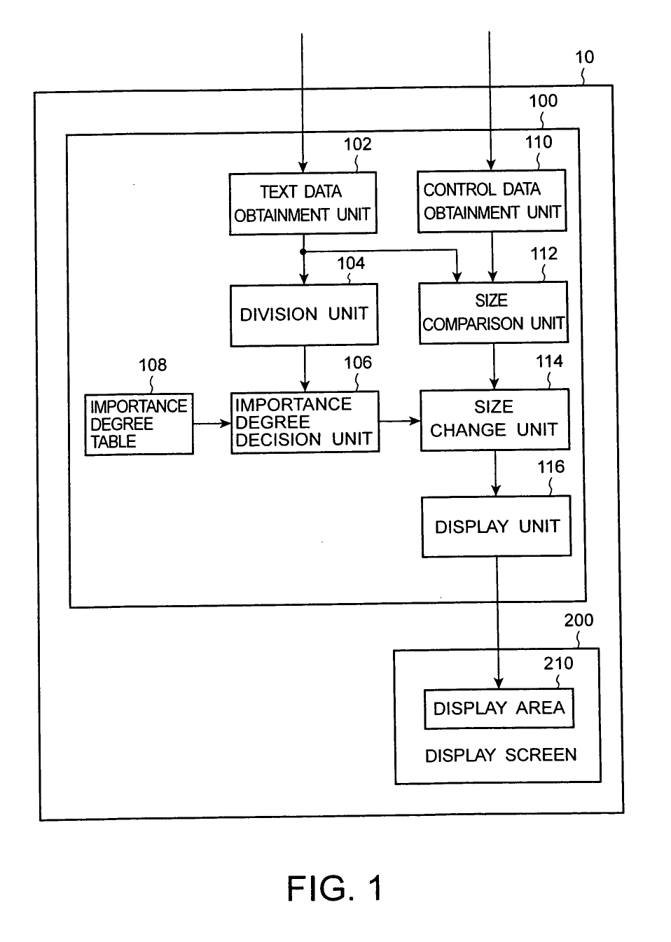

Hereinafter, various embodiments of the present invention will be explained by referring to the drawings. FIG. 1 is a block diagram of a character data display apparatus according to a first embodiment. The character data display apparatus 10 is composed as a text data editing apparatus.

The character data display apparatus includes a processing unit 100 to execute text data editing processing (featuring the character data display apparatus 10) and a display screen 200 to display text data processed by the processing unit 100. The text data processed by the processing unit 100 is displayed on a display area (screen area) 210 set in the display screen 200. The text data can be scrolled on the display area 210.

The processing unit 100 includes a text data obtainment unit 102, a division unit 104, an importance degree decision unit 106, an importance degree table 108, a control data obtainment unit 110, a size comparison unit 112, a size change unit 114, and a display unit 116.

The text data obtainment unit 102 obtains text data as character data to be displayed on the display screen (from the outside). For example, text data may be obtained by a user's input. Furthermore, text data may be obtained through a communication receiving means or a broadcast receiving means. Furthermore, text data stored in a recording medium may be read out.

The division unit 104 divides text data (obtained by the text data obtainment unit 102) into a plurality of units each including linguistic meaning. In the first embodiment, text data is divided into a plurality of part data by unit of a word. Furthermore, information of a part of speech of the word included in part data is assigned to each part data.

A unit including linguistic meaning is not limited to the word. For example, the unit may be “morpheme”, “phrase”, “continued phrases”, “sentence”, and “paragraph”.

The importance degree decision unit determines an importance degree of each part data (obtained by the division unit 104) using the importance degree table 108.

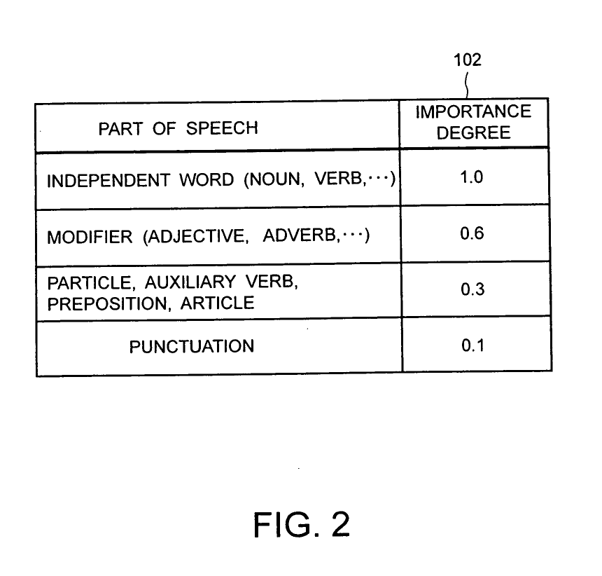

The importance degree table 108 is used for determining an importance degree of each part data. FIG. 2 shows data components of each part data. The importance degree table 108 correspondingly stores a part of speech of each word and the importance degree. Accordingly, by using the importance degree table 108, for example, the importance degree of a noun is specified as “1.0”.

The control data obtainment unit 110 obtains a set display speed (N) and a set display time (T) from the outside. The set display speed (N) represents a speed when all text data (obtained by the text data obtainment unit 102) is displayed on the display area. The set display time (T) represents a time taken for displaying all text data (obtained by the text data obtainment unit 102).

The control data obtainment unit 110 may obtain the set display speed (N) and the set display time (T) by a user's input. Briefly, the set display speed (N) and the set display time (T) are the user's desired value or arbitrary variable value. Furthermore, the control data obtainment unit 110 may obtain the set display speed (N) and the set display time (T) through an outside device.

In the case of obtaining control data from the user's input, the user inputs the set display speed according to the following conditions. In the case of standard speed display, the user inputs “N=1”. In the case of temporary stop, the user inputs “N=0”. In the case of low speed display, the user inputs “0<N<1”. In the case of high speed display, the user inputs “1<N<∞”. In the case of skip display, the user inputs “N=∞”. In the case of low speed reverse display, the user inputs “−1<N<0”. In the case of standard speed reverse display, the user inputs “N=−1”. In the case of high speed reverse display, the user inputs “N<−1”. In a computer, “∞” is used by replacing “∞” with a sufficient large numerical value.

The size comparison unit 112 obtains control data from the control data obtainment unit 110. The control data includes the set display speed (N) and the set display time (T). Furthermore, the size comparison unit 112 obtains text data from the text data obtainment unit 102. The size comparison unit 112 compares a total display size of text data (in the case of displaying the text data on the display area) with a display area size as an absolute size of the display area.

If the total display size is larger than the display area size, the size change unit 114 selects part data based on the importance degree (determined by the importance degree decision unit 106), and reduces a display size of the selected part data. In this case, the size change unit 114 determines a reduction ratio based on a comparison result of the size comparison unit 112.

The display unit 116 displays text data edited by the size change unit 114 on the display area 210. The display unit 116 displays the text data by scrolling on the display area 210.

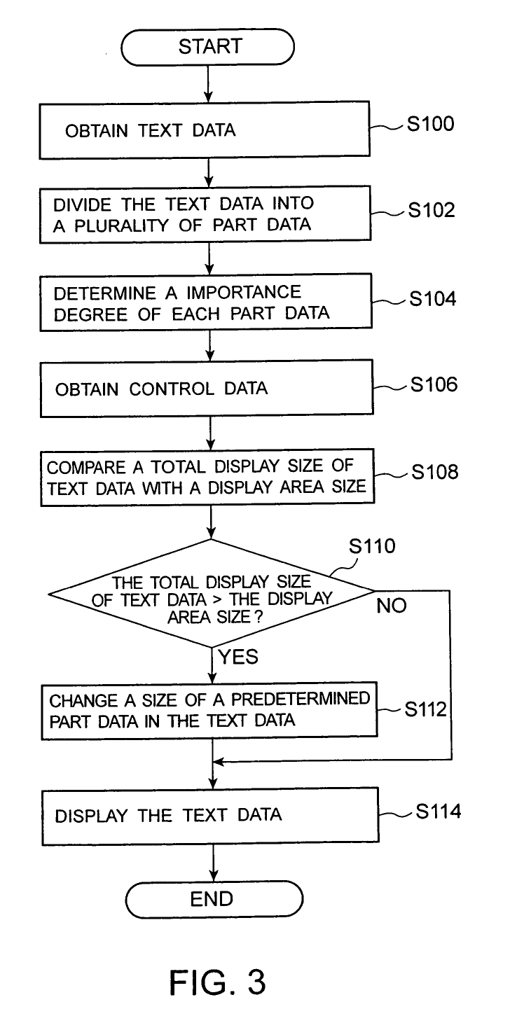

FIG. 3 is a flow chart of display processing of text data in the character data display apparatus 10. First, the text data obtainment unit 102 obtains text data from outside (S100). Next, the division unit 104 divides the text data into a plurality of part data by unit of a word (S102). Furthermore, the division unit 104 assigns a part display time to each part data. The part display time represents a time taken for displaying the part data on the display area.

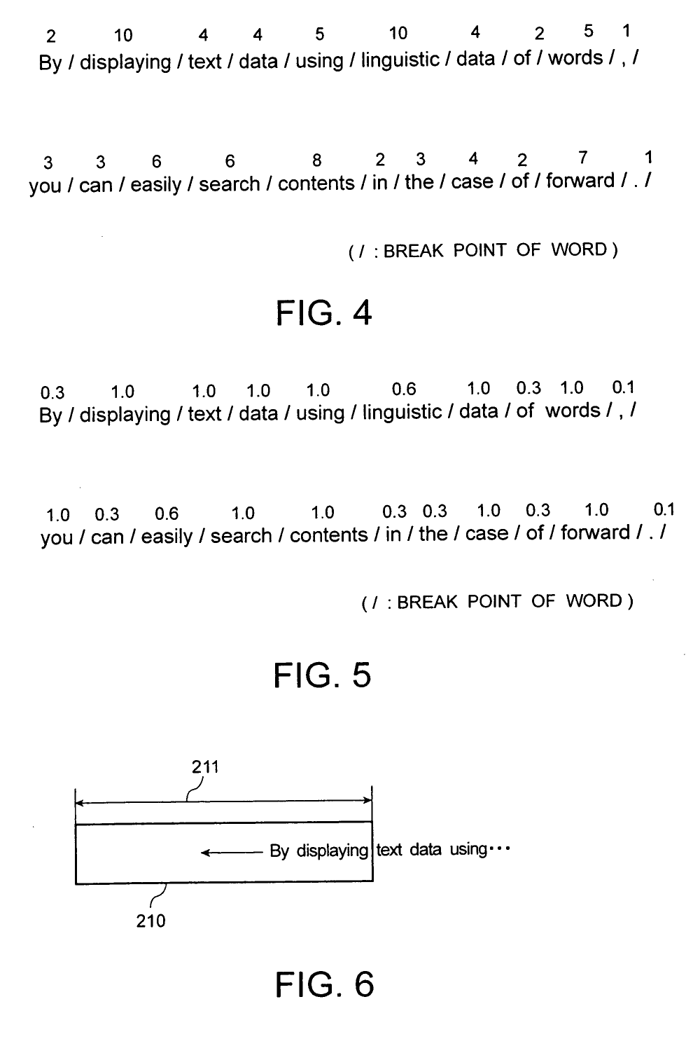

FIG. 4 shows part data obtained by division processing of the division unit 104. In FIG. 4, part data divided from text data “By displaying text data using linguistic data of words, you can easily search contents in the case of forward.” is shown, and “/” represents a break point of each part data (word)

As shown in the upper side of each part data of FIG. 4, the part display time is added to each part data. In the first embodiment, one character is displayed for one second by scrolling. For example, part data “By” has two characters. Accordingly, the part display time “2 seconds” is added to this word. In FIG. 4, all text data has ninety two (92) characters. Accordingly, the total display time (T₀) to display all of the text data is ninety two (92) seconds.

Next, by referring to the importance degree table 108, the importance degree decision unit 106 determines the importance degree of each part data based on a part of speech of the part data (S104). FIG. 5 shows the importance degree determined for each part data. For example, a part of speech of part data “By” is a preposition. Accordingly, by using the importance degree table 108, the importance degree is specified as “1.0” and assigned. The importance degree decision unit 106 outputs each part data to which the importance degree is assigned to the size change unit 114.

On the other hand, the control data obtainment unit 110 obtains the set display speed (N) and the set display time (T) from outside (S106). Next, based on control data (obtained from the control data obtainment unit 110) and text data (obtained from the text data obtainment unit 102), the size comparison unit 112 compares the total display size of text data (in the case of displaying the text data on the display area) with the display area size (S108).

FIG. 6 shows the display area 210 to display text data in the character data display apparatus 10. In the display screen 200, text data can be displayed by scrolling. As shown in FIG. 6, text data is moved from the right side to the left side on the display area 210. Accordingly, text data of which number of characters is larger than the number of characters corresponding to a display width 211 can be displayed on the display area 210.

The size comparison unit 112 sets the display area size as a size determined by an actual size of the display screen 200, the set display speed, and the set display time. For example, assume that ten characters can be displayed on the display width 211, that the set display speed is one character per one second, and that the set display time is thirty (30) seconds. In this case, thirty (30) characters can be displayed for thirty (30) seconds. Accordingly, the display area size corresponds to thirty (30) characters.

In the case that text data includes more than thirty (30) characters, the total display size of text data is decided to be larger than the display area size. Furthermore, in the case that text data includes less than thirty (30) characters, the total display size of text data is decided to be smaller than the display area size.

If the total display size of text data is larger than the display area size (Yes at S110), the size change unit 114 reduces the total display size by reducing selected part data (S112). The display unit 116 displays the reduced text data on the display area (S114).

On the other hand, if the total display size of text data is smaller than the display area size (No at S110), the display unit 116 displays the text data without reduction of part data (S114). In this way, display processing of character data is completed.

Reduction processing of the size change unit 114 is explained. By changing a display width of each part data along the scroll direction, the size change unit 114 changes the set display time. Concretely, by using the set display speed (N) and the set display time (T) included in the control data (obtained by the control data obtainment unit 110), the size change unit 114 calculates a reduction ratio of display width according to an equation (1).

$$( a reduction ratio of display width of {w}_{i} ) = \frac{1}{{a}_{i}} \times N \times \frac{T}{{T}_{0}} = \frac{1}{{a}_{i}} \times N \times \frac{{\sum }_{i} ( {a}_{i} \cdot {l}_{i} )}{{\sum }_{i} {l}_{i}} \qquad ( 1 )$$

In equation (1), “i” is order of each unit, “wᵢ” is a unit (word) , “lᵢ” is a display time of each unit, “aᵢ” is a weight (importance degree), “T₀” is a standard display time of all text data, “T” is the set display time, and “N” is the set display speed.

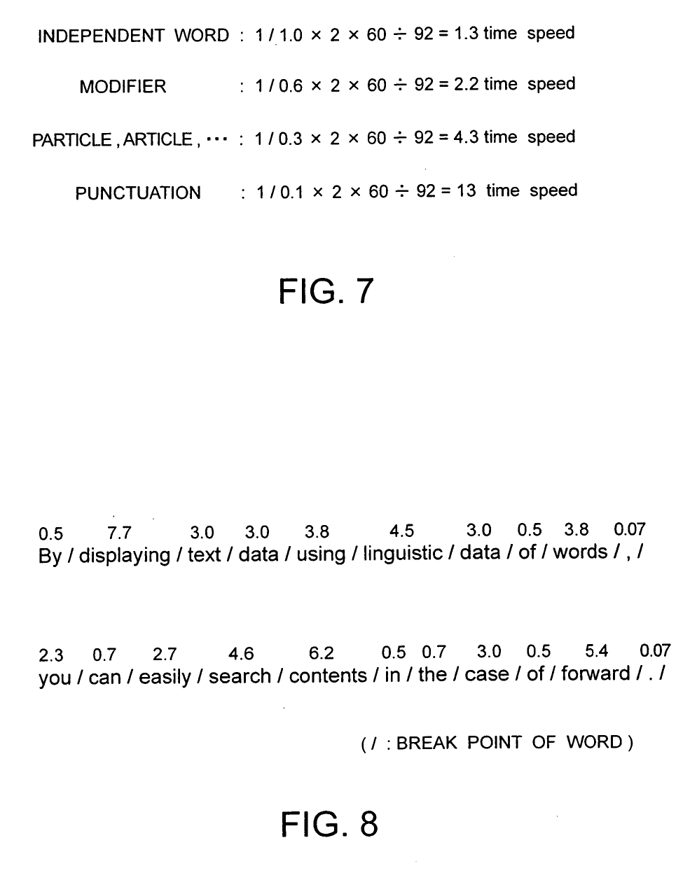

FIG. 7 shows a reduction ratio of display width of each part data (part of speech) calculated by the equation (1). In FIG. 7, the display time of all text data (T₀) is 92 seconds (the number of characters included in the text data), the set display time (T) is 60 seconds, and the set display speed (N) is 2 times (double speed).

Furthermore, the size change unit 114 calculates a part display time (Tᵢ) of each part based on the reduction ratio of display width. FIG. 8 shows the part display time of each part data calculated by the reduction ratio of display width shown in FIG. 7.

For example, by setting a display width of one character (one word) along the scroll direction as a half, a display time of the character (word) is reduced by half. In this case, a display speed of the character (word) doubles.

The size change unit 114 outputs the display time of part data shown in FIG. 8 as display control data to the display unit 116. The display unit 116 displays text data according to the display control data obtained from the size change unit 114.

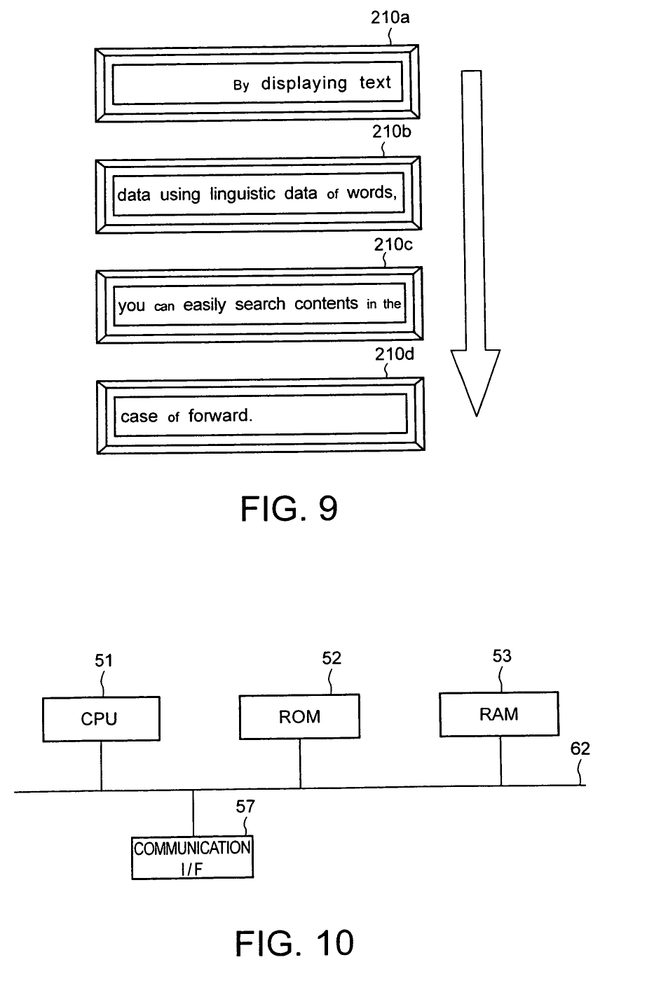

FIG. 9 shows a display situation of text data by the display unit 116. As shown in FIG. 9, by displaying each part data using a part display size corresponding to the part display time shown in FIG. 8, the total display size of text data can be reduced. The longer the display time is, the larger the display width of part data is. In FIG. 9, in order to briefly show a size change of each word, two display sizes are used for each part data. Concretely, a word having a display time above “1.0” is displayed as a large size and a word having a display time not above “1.0” is displayed as a small size. In the first embodiment, the part display size is reduced using the same reduction ratio along a vertical direction and a lateral direction (not the display width only).

As mentioned-above, by changing the display width of each part data without a scroll speed, the total display time of text data can be reduced. Furthermore, in the case of changing the display width, a character (word) such as a particle of which importance degree is relatively low for a user to understand contents of text data is preferentially set as a change object. Accordingly, after changing the display size of unimportant word, the user can easily understand the contents.

FIG. 10 shows hardware components of the character data display apparatus 10 according to the first embodiment. As the hardware components, the character data display apparatus 10 includes a ROM 52 to store a text data editing program to execute text data editing processing, a CPU 51 to control each unit of the character data display apparatus 10 and execute buffering time change processing based on the program of the ROM 52, a RAM 53 to store various data necessary for control of the character data display apparatus 10 by forming work area, an communication I/F 57 to communicate by connecting to a network, and a bus 62 to connect each unit.

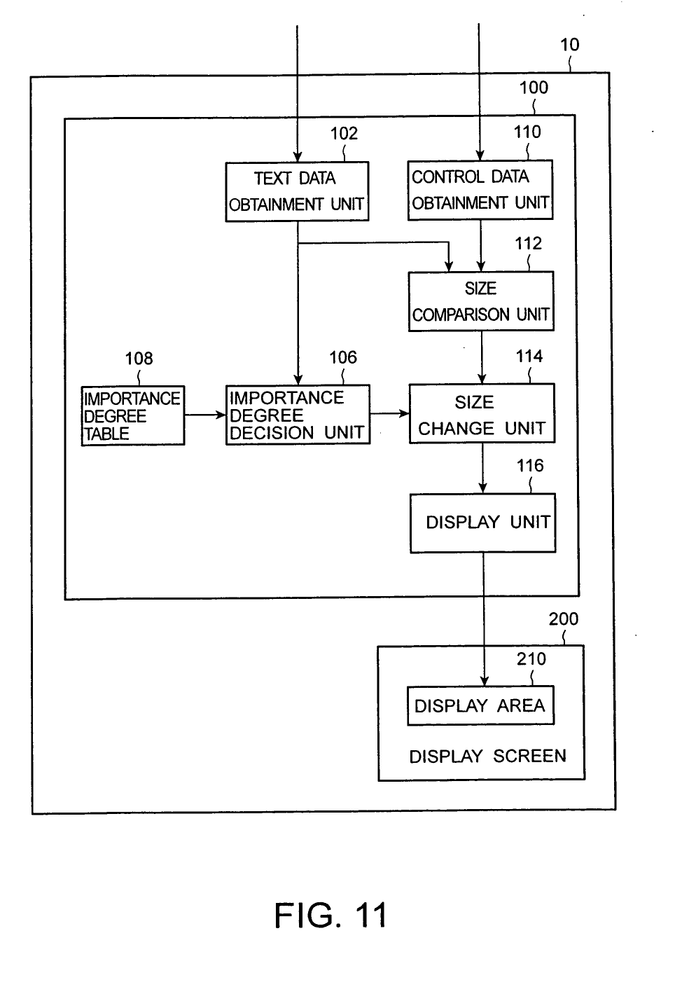

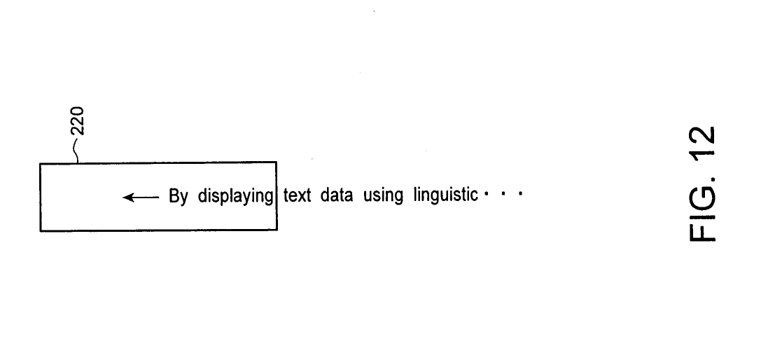

As a first modification of the first embodiment, the character data display apparatus 10 may obtain text data already divided into a plurality of part data from outside. FIG. 11 is a block diagram of the character data display apparatus 10 according to a first modification. As shown in FIG. 11, the processing unit 100 of the character data display apparatus 10 of the first modification does not include the division unit 104.

In the first modification, text data is previously divided into a plurality of part data by another apparatus, and the character display apparatus 10 obtains text data by unit of part data from outside. In this case, the importance degree decision unit 106 obtains text data as each part data from the text data obtainment unit 102. By processing explained in the first embodiment, the importance degree of each part data is determined. Other component and processing are the same as the first embodiment.

As a second modification of the first embodiment, the character data display apparatus 10 may not prepare the display screen 200. In this case, the display unit 116 outputs text data of which display size is changed to a display apparatus different from the character data display apparatus 10.

In the first embodiment, the size change unit 114 changes a display size of all part data based on the set display speed, the set display time and a standard display time of all text data. However, a display size of part data of low importance degree may be changed.

For example, a display size of part data of a punctuation of the lowest importance degree may be changed only. Furthermore, in the case that the total display size of text data is larger than a display area size irrespective of changing the display size of the punctuation, a display size of part data (such as a particle) of the second lowest importance degree may be changed.

Furthermore, a minimum size of part data may be determined. If a display size of part data (such as a punctuation) is calculated below the minimum size by limitation of the set display speed, the display size is uniformly set as the minimum size. In this case, if the total display size of text data is still larger than the display area size, a display size of part data (such as a particle) of the second lowest importance degree may be changed.

In the same way, if a display size of part data (such as a particle) is calculated to be below the minimum size by limitation of the set display speed, the display size is uniformly set as the minimum size. In this case, if the total display size of text data is still larger than the display area size, a display size of part data (such as an adjective) of the third importance degree may be changed. In this way, by changing a display size of part data in lower order of the importance degree of the part data, all display size of text data can be reduced while clearly displaying important words.

As a third modification, text data may be displayed using many (at least three) display sizes. For example, display sizes of three steps are prepared based on the importance degree. The size change unit 114 selects any of three sizes (large, middle, small) based on the importance degree of each part data, and changes a display size of each part data to the selected size.

In the first embodiment, edited text data is displayed on the display area 210 by scrolling along a lateral direction. However, as a fourth modification, as shown in FIG. 12, text data may be displayed on a display area 220 by scrolling along a vertical direction.

Furthermore, in the first embodiment, the size change unit 114 reduces a display size of a predetermined part data. However, as a fifth modification, the part data may be deleted. Briefly, part data of low importance degree may be deleted. In this case, by deleting a part of a plurality of part data consisting of text data, the total display size required for the text data can be reduced.

Furthermore, in the first embodiment, display processing is executed in order of steps shown in FIG. 3. However, as a sixth modification, a flow from text data obtainment processing (S100) to importance degree decision processing (S104), and control data obtainment processing (S106), are mutually independent. Accordingly, these processing may be executed in parallel, or the control data obtainment processing (S106) may be executed in advance.

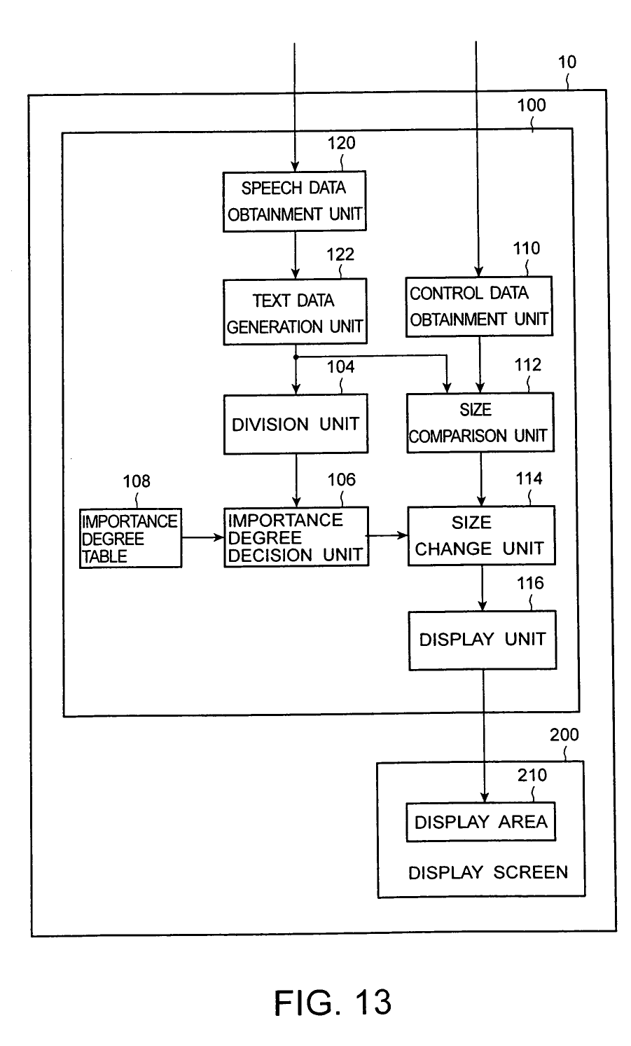

Next, the character data display apparatus 10 of the second embodiment is explained. In the second embodiment, by recognizing speech data obtained from outside, text data is generated. FIG. 13 is a block diagram of the character data display apparatus 10 of the second embodiment. The processing unit 100 includes a speech data obtainment unit 120 and a text data generation unit 122 in place of the text data obtainment unit 102. This feature is different from the first embodiment.

The speech data obtainment unit 120 obtains speech data from outside. The text data generation unit 122 obtains speech data from the speech data obtainment unit 120, analyzes utterance contents by recognizing the speech data, and generates text data.

For example, speech data may be obtained by a microphone input from a user. Furthermore, speech data may be obtained through a communication receiving means or a broadcast receiving means. Furthermore, speech data may be read from a recording medium.

In this way, the character data display apparatus 10 of the second embodiment can execute display processing of text data generated from speech data. Other components and processing of the second embodiment are the same as in the first embodiment.

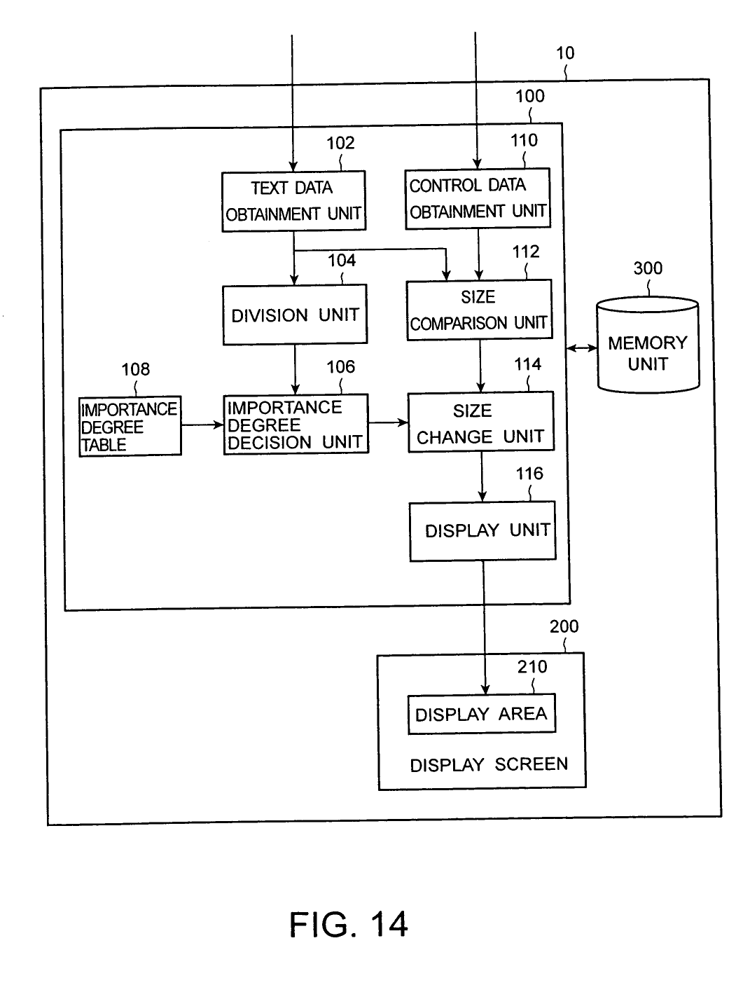

Next, the character data display apparatus 10 of the third embodiment is explained. FIG. 14 is a block diagram of the character data display apparatus 10 of the third embodiment. In the third embodiment, a memory unit 300 is included in addition to components of the first embodiment. This feature is different from the first and second embodiments.

For example, the memory unit 300 is composed of a semiconductor memory, a hard disk, or an optical recording medium. Furthermore, the memory unit 300 is attachable to the character data display apparatus 10.

In the third embodiment, for example, the processing unit 100 calculates a part display time (Tᵢ) of each part data before displaying text data. The memory unit 300 stores the calculated part display time (Tᵢ).

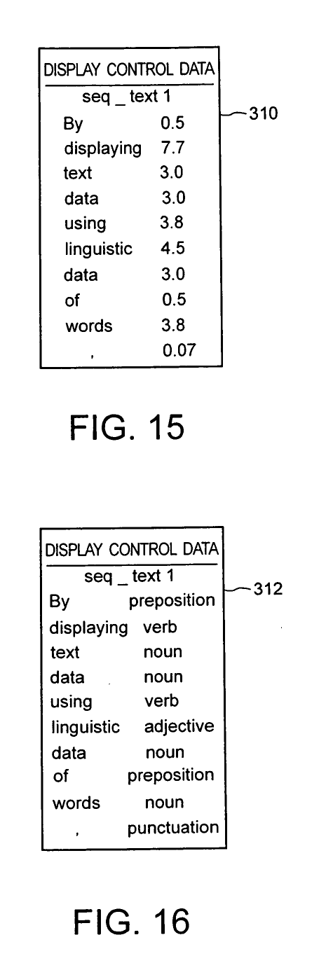

FIG. 15 shows one example of display control data stored in the memory unit 300. As shown in FIG. 15, display control data 310 correspondingly include each part data and the part display time.

The size change unit 114 reads the display control data 310 from the memory unit 300 in response to a display indication. Based on control data obtained by the control data obtainment unit 110, the size change unit 114 executes size change processing.

In this way, the memory unit 300 stores the display control data as intermediate data used for changing a display size of text data. Accordingly, in the case of non-displaying text data at obtainment timing, by storing the display control data 310 in the memory unit 300, display processing of text data can be quickly executed at output timing.

Furthermore, the memory unit 300 is attachable to the character data display apparatus 10. Accordingly, by reading contents of the memory unit 300 into another display apparatus, quick display of text data can be executed in another apparatus. In the character data display apparatus 10 of the third embodiment, other component and processing are the same as in the first embodiment.

In the third embodiment, the memory unit 300 stores a part display time of each part data as display control data. However, contents of the display control data 310 stored in the memory unit 300 are not limited to FIG. 15.

As a modification, as shown in FIG. 16, display control data 312 may correspondingly include each part data and the part of speech. In this case, in response to a display indication, the importance degree decision unit 106 determines the importance degree based on the part of speech. Hereafter, processing following from S104 in FIG. 3 is executed.

Next, the character data display apparatus 10 of the fourth embodiment is explained. In the fourth embodiment, text data is displayed in synchronization with speech data and video data.

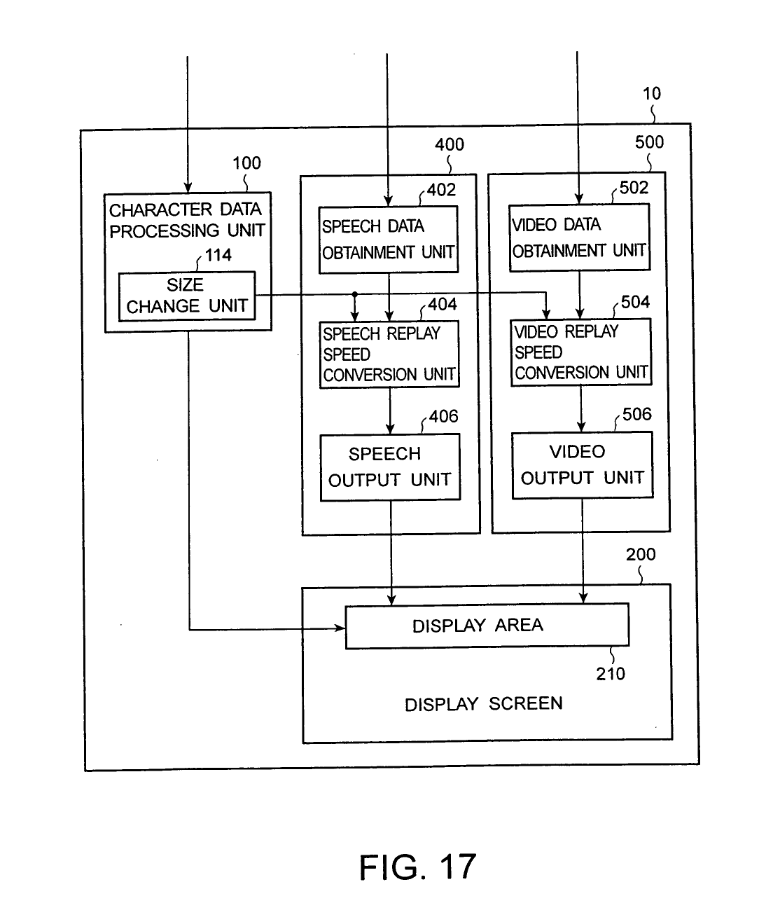

FIG. 17 is a block diagram of the character data display apparatus 10 of the fourth embodiment. The character data display apparatus 10 of the fourth embodiment includes a speech data processing unit 400 and a video data processing unit 500 in addition to the processing unit 100 and the display screen 200 of the first embodiment. This feature is different from the above-mentioned embodiments.

The speech data processing unit 400 includes a speech data obtainment unit 402, a speech replay speed conversion unit 404, and a speech output unit 406. The video data processing unit 500 includes a video data obtainment unit 502, a video replay speed conversion unit 504, and a video output unit 506.

The speech data obtainment unit 402 obtains speech data to be output in synchronization with text data from outside. The speech replay speed conversion unit 404 obtains speech data from the speech data obtainment unit 402, and a set display speed (N) and a set display time (T) from the size change unit 114. The speech replay speed conversion unit 404 reduces a replay time of speech data based on the set display speed (N) and the set display time (T).

The speech output unit 406 outputs speech data (of which replay time is reduced by the speech replay speed conversion unit 404) in synchronization with the display of text data by the processing unit 100.

The video data obtainment unit 502 obtains video data to be output in synchronization with text data from outside. The video replay speed conversion unit 504 obtains video data from the video data obtainment unit 502, and obtains a set display speed (N) and a set display time (T) from the size change unit 114. The video replay speed conversion unit 504 reduces a replay time of video data based on the set display speed (N) and the set display time (T).

The video output unit 506 displays video data (of which replay time is reduced by the video replay speed conversion unit 504) on the display screen 200 in synchronization with display of the text data by the display unit 116.

In this way, in the character data display apparatus 10 of the fourth embodiment, text data of which display size is changed can be displayed in synchronization with video data and speech data. Other components and processing of the character data display apparatus 10 of the fourth embodiment are the same as in the first embodiment.

In the character data display apparatus 10 of the fourth embodiment, a replay time is reduced by processing speech data and video data. However, as a first modification of the fourth embodiment, speed of data obtainment by the speech data obtainment unit 402 and the video data obtainment unit 502 may be controlled. As a result, the replay time can be reduced.

Furthermore, in the fourth embodiment, the character data display apparatus 10 respectively obtains speech data and text data. However, as a second modification, text data may be obtained from speech data obtained by the speech data obtainment unit 402. Concretely, as shown in FIG. 13, the processing unit 100 includes the speech data obtainment unit 120 and the text data generation unit 122 instead of the text data obtainment unit 102. The speech data obtainment unit 120 obtains speech data from the speech data obtainment unit 402.

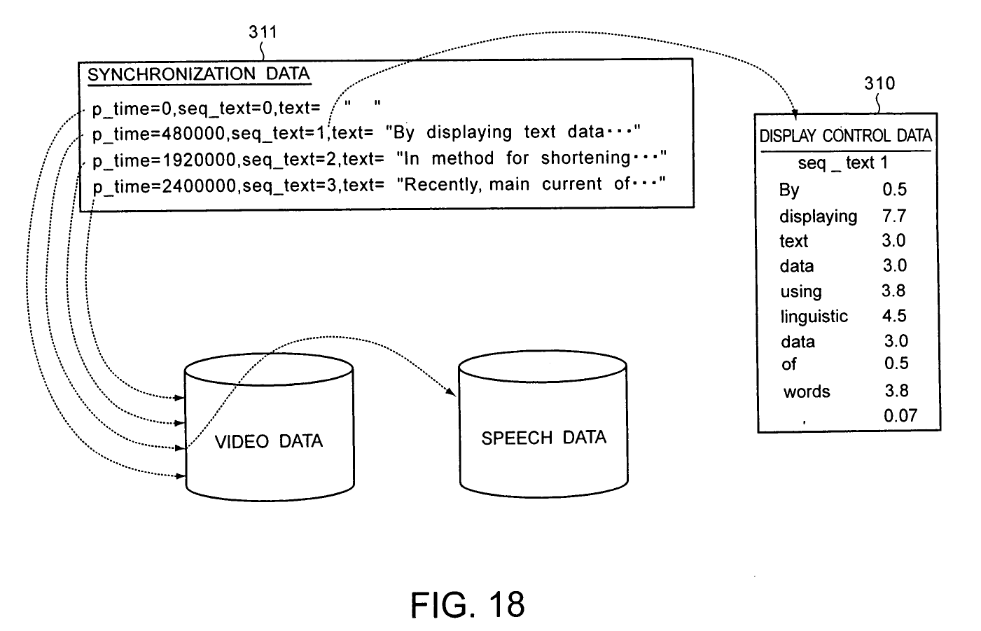

As a third modification, the processing unit 100 may change a size of text data based on reduction of video data and speech data. Furthermore, the character data display apparatus 10 may include a memory unit. FIG. 18 shows information stored in the memory unit. In the fourth embodiment, in addition to display control data 310 stored in the memory unit 300 of FIG. 15, the memory unit stores synchronization data 311. The synchronization data 311 links a replay time of speech data and video data with a display time of each part data.

For example, in the synchronization data 311, p_time=480000, seq_text=1, and text=“By displaying text data . . . ”, are correspondingly stored. By referring to this information, in the case of outputting speech data and video data at a replay time “p_time=480000”, text of “seq_text=1” is displayed. In this way, by using information stored in the memory unit, speech data, video data, and text data can be synchronously output.

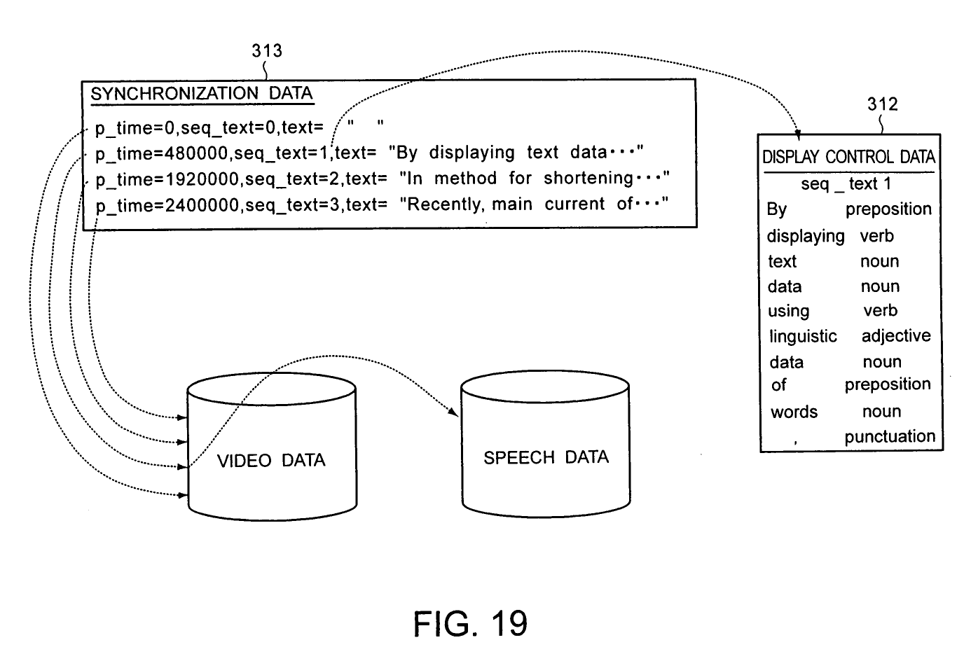

As a fourth modification, in the same way as in the third embodiment, contents of display control data 310 are not limited to FIG. 18. FIG. 19 shows another data stored in the memory unit. In addition to display control data 312 shown in FIG. 16, synchronization data 313 are stored. In this case, by using information stored in the memory unit, speech data, video data, and text data can be synchronously output.

Next, the character data display apparatus 10 of the fifth embodiment is explained. In the character data display apparatus 10 of the fifth embodiment, character data is displayed on a character display area vertically scrolling each character line. Briefly, the character data display apparatus 10 executes character data display processing based on a display format scrolling line by line.

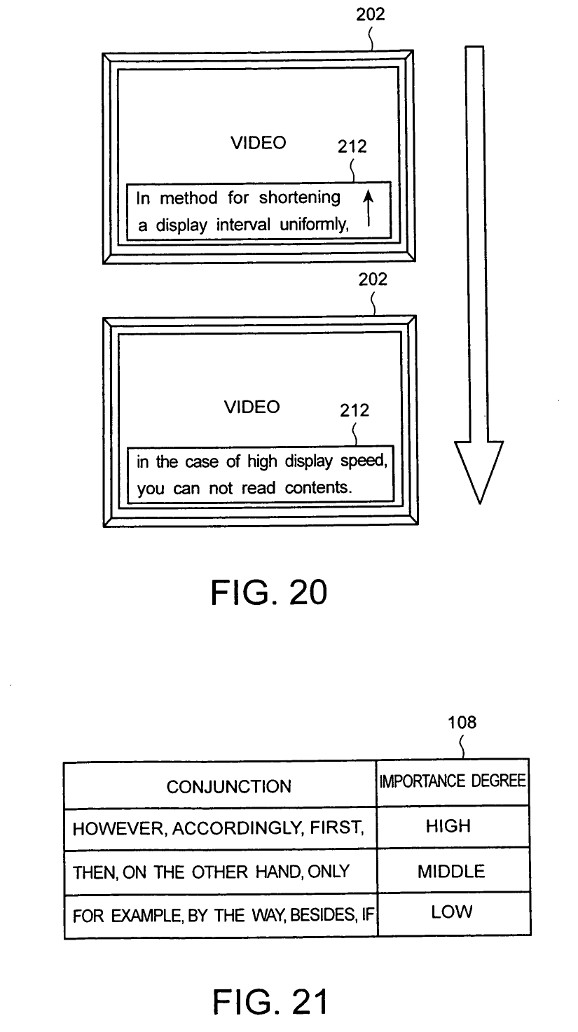

FIG. 20 shows a display screen 202 and a display area 212 according to the fifth embodiment. Text data is displayed on the display area 212. In the display area 212, information is scrolled from the lower side to the upper side. Briefly, text data is scroll-displayed line by line.

FIG. 21 shows data components of the importance degree table 108 according to the fifth embodiment. In the importance degree table 108, a conjunction and an importance degree are correspondingly stored. Accordingly, by using the importance degree table 108, for example, the importance degree of part data including a conjunction “However” is specified as “1.0” (high value).

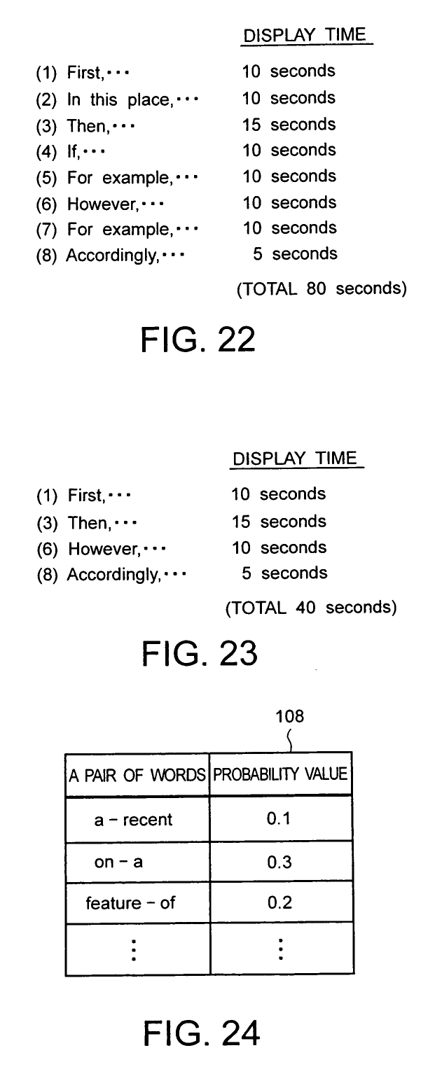

FIG. 22 shows text data obtained by the text data obtainment unit 102. In FIG. 22, only conjunctions included in part data (1)˜(8) are shown and other data are omitted. The division unit 104 divides text data into each part data by a phase unit as shown in FIG. 22.

Hereafter, the case that the control data obtainment unit 110 obtains a set display speed “two times” and a set display time “forty (40) seconds” and the total display time of text data is “eighty (80) seconds” is explained. In this case, the total display time of text data is reduced to “forty (40) seconds” because the set display speed is “two times”. Briefly, a display size of text data is reduced as a half.

Concretely, by referring to the importance degree table 108, the importance degree decision unit 106 determines an importance degree of each part data obtained from the division unit 104. Furthermore, the size comparison unit 112 decides that a display area size is double the total available display size for text data. The size change unit 114 selects the part data including the conjunction in higher order of the importance degree. In this case, the part data is selected so that a total of display time of selected part data is within and near the set display time “forty (40) seconds” as much as possible.

In this way, the size change unit 114 generates display control data including a part data identifier specifying selected part data. The display unit 116 displays part data specified by the display control data on the display area 212.

FIG. 23 shows text data displayed on the display area 212. Briefly, part data shown in FIG. 23 were selected from text data shown in FIG. 22. In this way, the size change unit 114 selects part data to be displayable within the set display time in higher order of the importance degree, and deletes other part data. As a result, text data can be displayed without reduction of display size of each character and enlargement of display speed of all text data.

In the importance degree table 108 of the fifth embodiment, the conjunction and the importance degree are correspondingly stored. However, information to be used for decision of the importance degree is not limited to the conjunction. For example, a number of words, a number of characters, a number of independent words (such as a noun and a verb), a ratio of independent words, may be decided for each part data. In this case, a priority degree of each part data may be determined based on this result.

Furthermore, as another example, a threshold may be previously set to the set display speed. In the character data display apparatus 10 of the fifth embodiment, display time of all text data is determined based on the set display speed (N) indicated by the user. In the case that the set display speed (N) is set as a high value, a number of part data to be displayable is few.

Accordingly, in the case that a number of displayable units is below the threshold, the size change unit 114 changes the set display speed (N) to low speed, and selects all part data to be displayable in a display time determined by the changed display speed. In this way, text data can be displayed in a condition for the user to easily view. Components and processing of the character data display apparatus 10 of the fifth embodiment are the same as in the first embodiment.

Next, in the character data display apparatus 10 of the sixth embodiment, the size change unit 114 determines the importance degree based on a use frequency of each part data. This feature is different from the character data display apparatus 10 of the above-mentioned embodiments. Furthermore, in the sixth embodiment, text data is displayed on the display area 212 shown in FIG. 20.

FIG. 24 shows data components of the importance degree table 108 of the sixth embodiment. In the importance degree table 108, a pair of words and a probability value are correspondingly stored. Concretely, a combination of two words corresponds to a probability value based on a use frequency of the combination of two words. The probability value is previously calculated based on various kinds of documents (such as newspapers and magazines) sampled at random. As a result, the probability value of expression often used in the world (combination of words often used in general) is large. On the other hand, the probability value of expression not used in the world (combination of words not used in general) is small.

Briefly, combination of words corresponding to a large probability value is an expression often used. Accordingly, even if this combination is not correctly displayed, the combination of words can be easily estimated from front and rear text by the user. On the other hand, combination of words corresponding to a small probability value is a unique expression. Accordingly, this combination of words can not be easily estimated from front and rear text by the user. The importance degree decision unit 106 decides that the importance degree of a combination of words having a smaller probability value is larger.

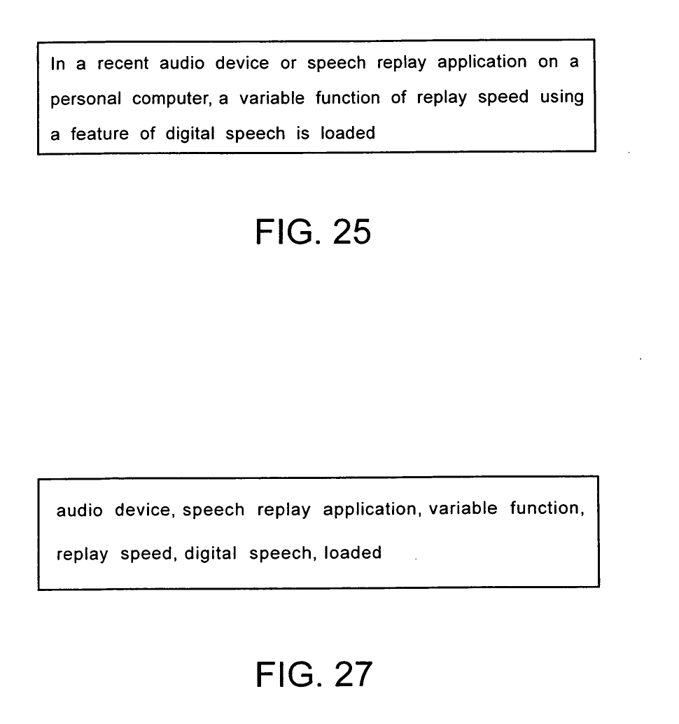

Hereafter, processing in the case that the text data obtainment unit 102 obtains text data shown in FIG. 25 and the control data obtainment unit 110 obtains a set display speed “one point five (1.5) times” is explained. Assume that a display time of all text data is one hundred and thirty two (132) seconds (as the number of characters included in text data of FIG. 25.).

First, by obtaining text data from the text data obtainment unit 102, the division unit 104 divides the text data into part data by unit of word (i.e. each part has one word). Furthermore, the division unit 104 sets a pair of words by combining contiguous two part data.

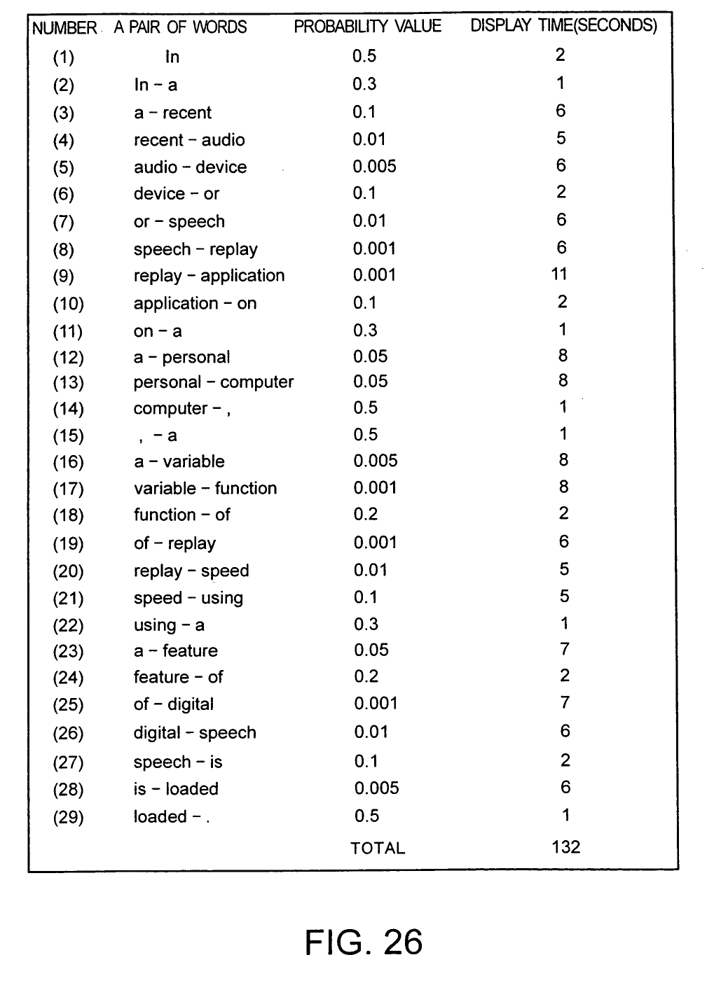

The size comparison unit 112 sets an actual display time “eighty eight (88) seconds” because of the set display speed “one point five (1.5) times”, and compares a display size of text data with the actual display time. The importance degree decision unit 106 determines a probability value of each pair of words by referring to the importance degree table 108. FIG. 26 shows each pair of contiguous two words (obtained by the division unit 104) and a probability value of each pair of contiguous two words.

The size change unit 114 determines part data as an editing object based on the probability value shown in FIG. 26. As mentioned-above, the size change unit 114 decides that the importance degree of a pair of words having a smaller probability value is larger. Concretely, in each pair (1)˜(29) of contiguous two word of FIG. 26, a pair having a probability value below a predetermined threshold is regarded as a display object of low speed (normal speed). On the other hand, a pair having a probability value above the predetermined threshold is regarded as a display object of high speed (double speed).

For example, in the case of the predetermined threshold “0.01”, the right side word of pairs of words (4) (5) (7) (8) (9) (16) (17) (19) (20) (25) (26) (28) in FIG. 26 are set as display objects of low speed. On the other hand, the right side word of pairs of words (1) (2) (3) (6) (10) (11) (12) (13) (14) (15) (18) (21) (22) (23) (24) (27) (29) in FIG. 26 are set as display objects of high speed.

Furthermore, the size change unit 114 determines a display speed of high speed display. Concretely, first, the size change unit 114 detects that a display time to display the right side words of pairs of words (4) (5) (7) (8) (9) (16) (17) (19) (20) (25) (26) (28) in FIG. 26 is eighty (80) seconds (total of corresponding display time in FIG. 26). Second, the size change unit 114 decides to display the right side word of pairs of words (1) (2) (3) (6) (10) (11) (12) (13) (14) (15) (18) (21) (22) (23) (24) (27) (29) in FIG. 26 within eight (8) seconds (=eighty eight (88) seconds (actual display time)−eighty (80) seconds (display time of the right side words of pairs of words (4) (5) (7) (8) (9) (16) (17) (19) (20) (25) (26) (28))). Briefly, display speed of high speed display is set as six point five (6.5) times (=fifty two (52) seconds (total of corresponding display time of (1) (2) (3) (6) (10) (11) (12) (13) (14) (15) (18) (21) (22) (23) (24) (27) (29) in FIG. 26)÷eight seconds)

Furthermore, the size change unit 114 generates display control data representing a display speed of each part data, and sends the display control data to the display unit 116. The display unit 116 displays part data of pairs of words (4) (5) (7) (8) (9) (16) (17) (19) (20) (25) (26) (28) at a normal speed, and displays part data of pairs of words (1) (2) (3) (6) (10) (11) (12) (13) (14) (15) (18) (21) (22) (23) (24) (27) (29) at six point five (6.5) times speed.

FIG. 27 shows text data displayed on the display area 212. Part data displayed at 6.5 time speed almost can not be seen by a user. As a result, as shown in FIG. 27, the user can recognize only part data displayed at a normal speed as characters.

As mentioned-above, in the character data display apparatus of the sixth embodiment, a display speed of non-general expression is set at low speed. Accordingly, in comparison with uniform high display speed of all text data, contents of text data can be displayed for the user to easily understand. Other components and processing of the character data display apparatus 10 of the sixth embodiment are the same as in the first embodiment.

In FIG. 26, contiguous two words are classified as a pair of words (1)˜(29). However, as a first modification of the sixth embodiment, contiguous three words or more may be classified as each unit.

Furthermore, in the sixth embodiment, the threshold of possibility value is a fixed value. However, as a second modification, the size change unit 114 may arbitrarily change the threshold. For example, first, the size change unit 114 calculates a total of display time of part data to be displayed at a normal speed by using a set threshold. In this case, if the total is above the actual display time determined from a set display speed obtained by the control data obtainment unit 110, the size change unit 114 may change the threshold.

Furthermore, as a third modification, in place of setting display speed of two steps to each part data, display speed of three steps or more may be set. Furthermore as a fourth modification, in place of quickening a display speed, corresponding part data may be deleted.

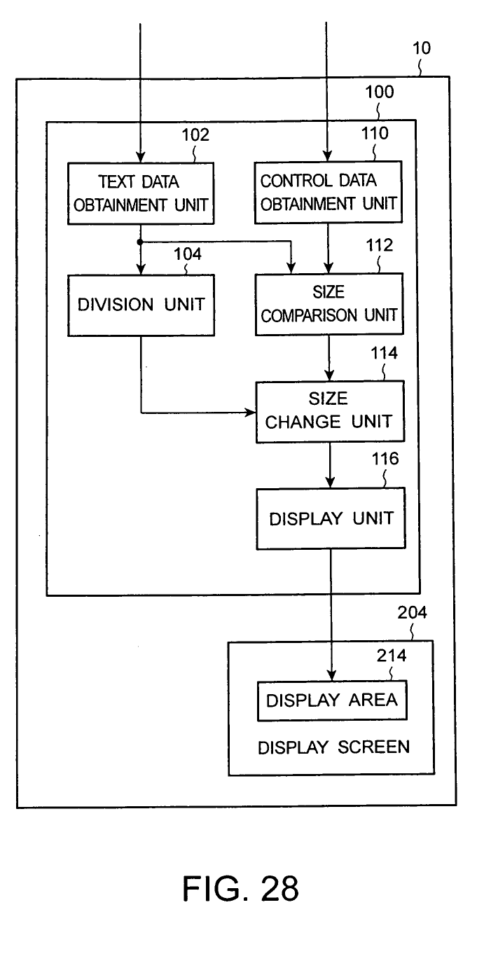

FIG. 28 shows a block diagram of the character data display apparatus according to a seventh embodiment. In the seventh embodiment, character data to be displayed on the display area 214 is displayed in order by changing at a predetermined interval. This feature is different from other embodiments.

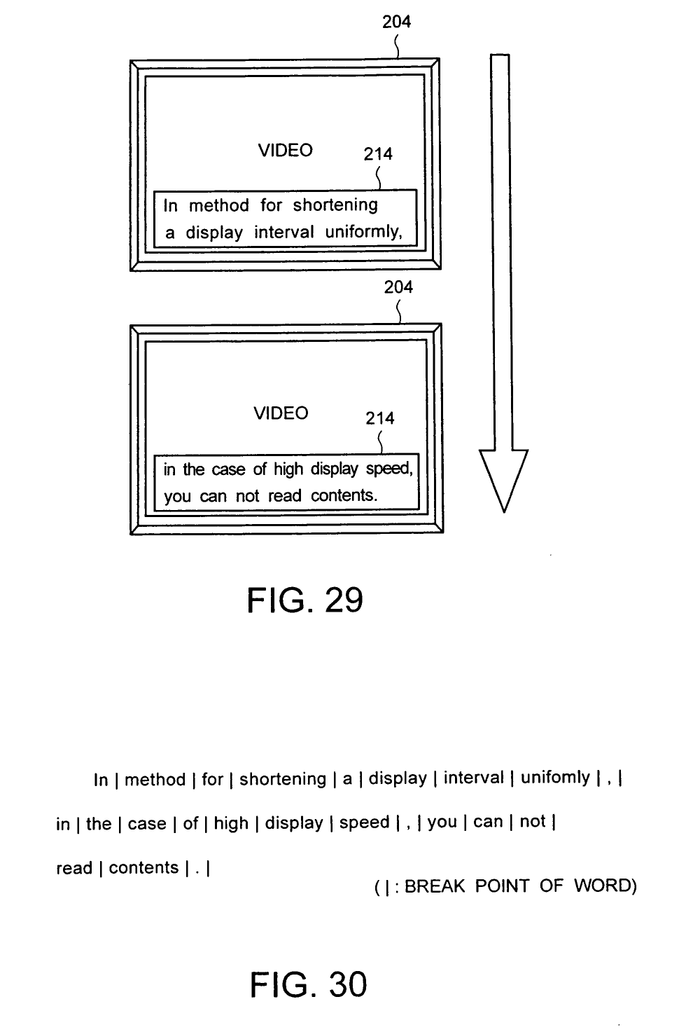

FIG. 29 shows a display screen 204 and a display area 214 according to the seventh embodiment. Text data is displayed on the display area 214 in order. For example, the text data is changed by unit of two lines at every three seconds.

Furthermore, in the seventh embodiment, the processing unit 100 does not include the importance degree decision unit 106 and the importance degree table 108. Briefly, in the character data display apparatus 10 of the seventh embodiment, part data as an editing object is selected based on a predetermined rule irrespective of importance degree of each part data.

FIG. 30 shows part data divided by the division unit 104. In this case, part data of text data “In method for shortening a display interval uniformly, in the case of high display speed, you can not read contents.” are shown. In FIG. 30, “|” represent a break point of word.

The division unit 104 divides text data into part data by unit of word. However, division unit is not limited to a word. For example, division unit may be “morpheme”, “phrase”, “sentence”, or “paragraph”. The division unit 104 may determine a division unit by a width of the display area 214 and a character size of the text data.

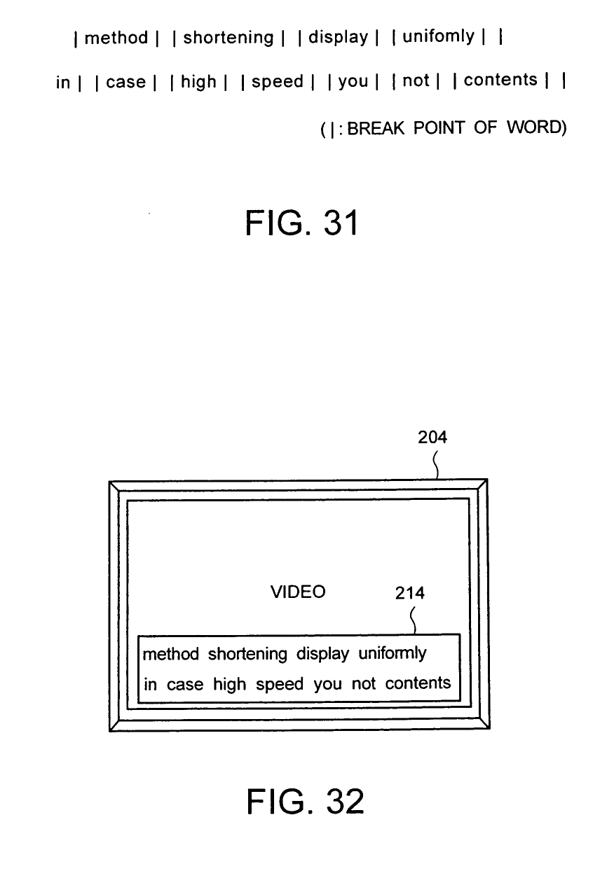

Furthermore, the size change unit 114 deletes a particular part data based on a set display speed (N) obtained from the control data obtainment unit 110. Hereafter, the case that the display speed is set as two times (double) is explained. In this case, the size change unit 114 deletes the number of part data by half. Concretely, as shown in FIG. 30, a plurality of part data arranged in order of text data is alternately deleted. FIG. 31 shows text data from which part data is alternately deleted. FIG. 32 shows text data of FIG. 31 displayed on the display area 214.

Furthermore, for example, in the case that the display speed is set as three times, in contiguous three part data arranged in order of text data, one part data may remained for each two part data deleted. In this way, part data is deleted based on the set display speed.

As mentioned-above, in the seventh embodiment, the user can understand a summary of text data because part data is alternately deleted. Furthermore, it is not necessary to reduce a size of each character and shorten an interval of display change. Accordingly, each character can be displayed at a size and speed easy for the user to view. Other components and processing of the character data display apparatus 10 of the seventh embodiment are the same as in the first embodiment.

In the seventh embodiment, part data is thinned based on arrangement rule such as alternation. However, a method for thinning part data is not limited to this rule. For example, part data including many Chinese characters may be preferentially remained. In this case, part data including important words to understand contents of text data can be remained. In this way, part data may be thinned based on a rule taking into consideration of contents of part data.

Furthermore, as shown in the fourth embodiment of FIG. 17, the character data display apparatus 10 may include the speech data processing apparatus 400 and the video data processing apparatus 500. In this case, the processing unit 100 may display text data in synchronization with speech data and video data.

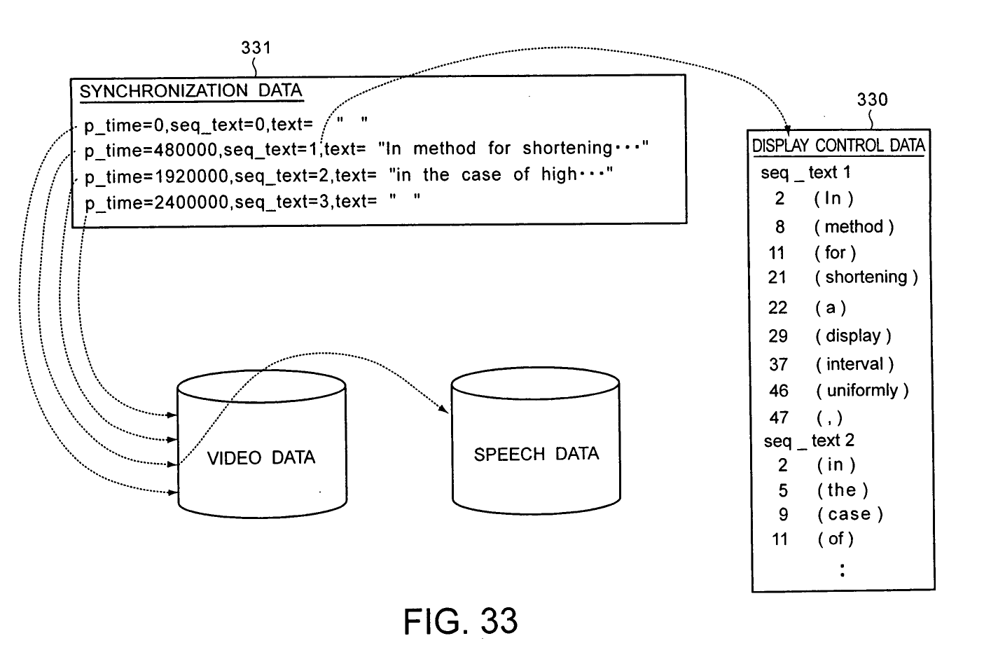

Furthermore, the character data display apparatus 10 may include a memory unit. FIG. 33 shows data component of data stored in the memory unit. As shown in FIG. 33, the memory unit stores display control data 330 and synchronization data 331 of text data.

In the display control data 330, a divisional position (break point) is represented by a number of characters from the head of text data. In this case, information representing which part data is to be deleted is not stored. The size change unit 114 determines part data to be deleted in response to the set display speed from the control data obtainment unit 110. In this way, by using information stored in the memory unit, text data, speech data, and video data can be simultaneously output.

Next, the character data display apparatus 10 of the eighth embodiment is explained. In the character data display apparatus 10 of the eighth embodiment, in the same way as in the sixth embodiment, character data is displayed in order on the display area by changing at a predetermined interval. Especially, in the eighth embodiment, part data to be deleted is determined based on appearance frequency of predetermined words included in each part data. This feature is different from other embodiments.

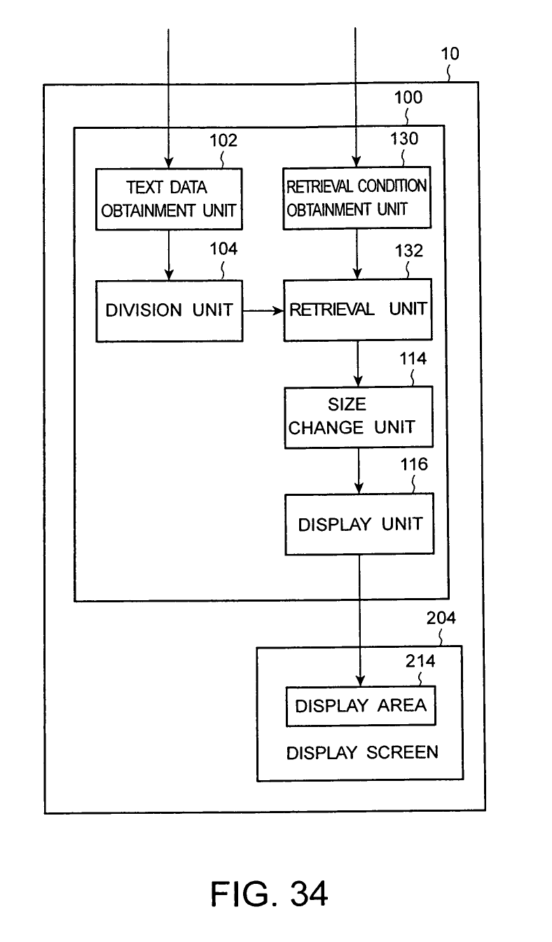

FIG. 34 is a block diagram of the character data display apparatus 10 of the eighth embodiment. In the eighth embodiment, the processing unit 100 includes the text data obtainment unit 102, the division unit 104, the size change unit 114, and the display unit 116. Furthermore, in place of the importance degree decision unit 106, the importance degree table 108, the control data obtainment unit 110, and the size change unit 112 of the first embodiment, the processing unit 100 of the eighth embodiment includes a retrieval condition obtainment unit 130 and a retrieval unit 132. Furthermore, the display screen 204 includes a display area 214 for changeable display contents.

The retrieval condition obtainment unit 130 obtains a retrieval condition to retrieve a predetermined word (from part data) from the outside. The retrieval condition includes a keyword as a retrieval object and an extraction threshold. The extraction threshold represents a threshold of the number of appearance as a value to decide whether part data is deleted.

The retrieval unit 132 obtains part data from the division unit 104, obtains the retrieval condition from the retrieval condition obtainment unit 130, and selects part data matched with the retrieval condition from the obtained part data. Briefly, the retrieval unit 132 selects part data in which the keyword frequently appears more than the extraction threshold.

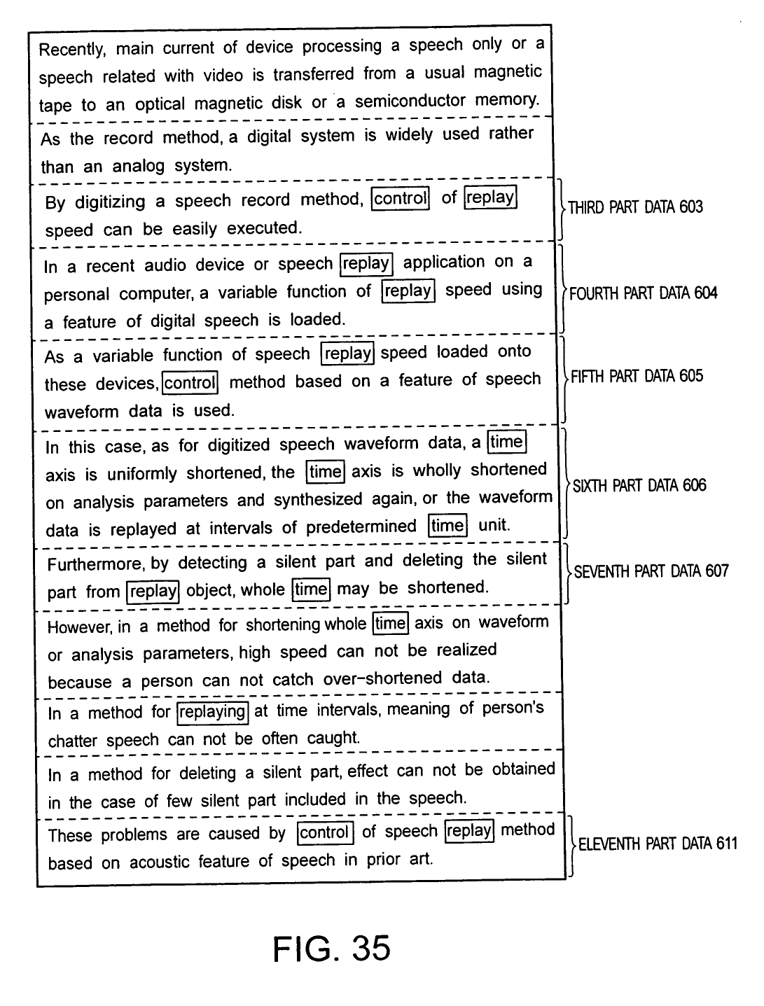

FIG. 35 shows part data obtained by the division unit 104. In the eighth embodiment, the division unit 104 divides text data into part data by unit of a sentence (i.e. each part is one sentence). In FIG. 35, a broken line represents a break point of part data.

In FIG. 35, three keywords “replay”, “time”, and “control” are indicated. Furthermore, retrieval result in the case of the extraction threshold “2” is additionally shown. As shown in FIG. 35, the third part data 603, the fourth part data 604, the fifth part data 605, the sixth part data 606, the seventh part data 607, and the eleventh part data 611, respectively include at least two keywords.

The size change unit 114 keeps part data matched with the retrieval condition (decided by the retrieval unit 132) and deletes other part data. The display unit 116 displays text data from which the other part data is deleted on the display area 214.

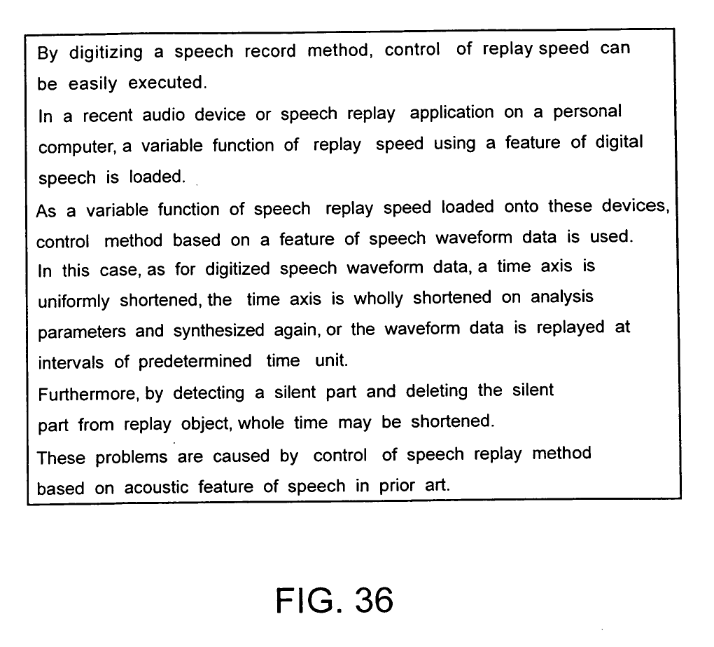

FIG. 36 shows text data displayed on the display area 214. In this way, by deleting the other part data, a display size of all text data can be reduced without reducing a display size of each character or shortening a display interval. Other components and processing of the character data display apparatus 10 of the eighth embodiment are the same as in the first embodiment.

In the eighth embodiment, the size change unit 114 deletes part data not matched with the retrieval condition by extraction threshold. However, a display interval of part data not matched with the retrieval condition may be shortened.

Furthermore, in the same way as in the fourth embodiment of FIG. 17, the character data display apparatus 10 may include the speech data processing unit 400 and the video data processing unit 500. In this case, the processing unit 100 may display text data in synchronization with speech data and video data.

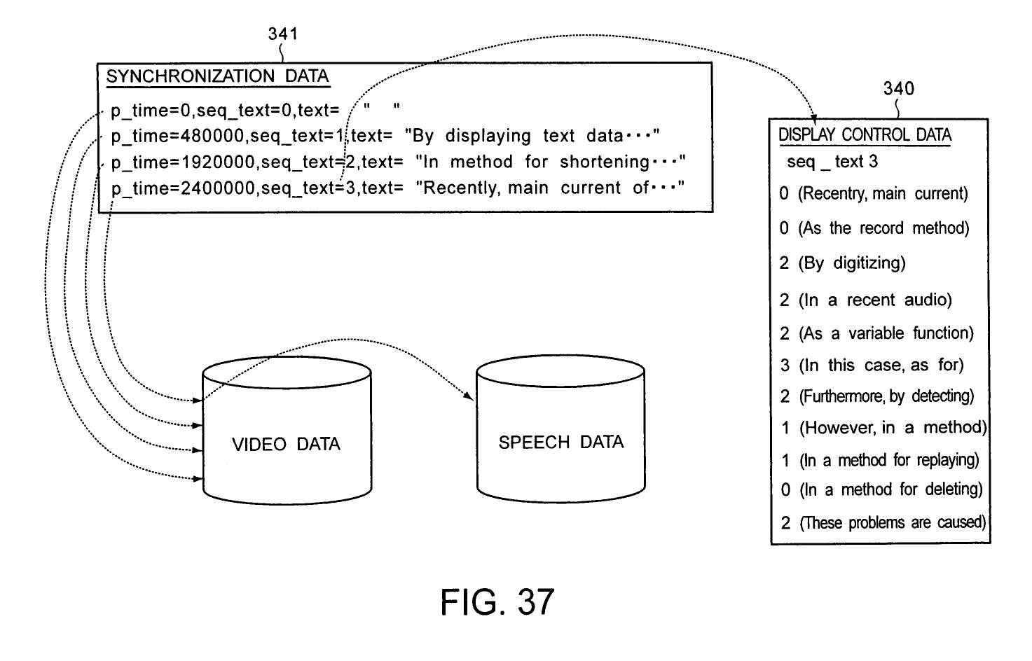

Furthermore, the character data display apparatus 10 includes a memory unit. FIG. 37 shows data components of the memory unit. The memory unit stores display control data 340 and synchronization data 341. The display control data 340 includes the number of keywords extracted from each part data. In this case, part data itself may not be stored.

As mentioned-above, in a text data editing apparatus, the total display size of text data may be partially reduced by editing a part data unit of linguistic meaning. Accordingly, even if the total display size of the text data is reduced, the user can easily understand contents of text data.

In the disclosed embodiments, the processing can be accomplished by a computer-executable program, and this program can be realized in a computer-readable memory device.

In the embodiments, the memory device, such as a magnetic disk, a floppy disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

1. An apparatus for editing text data, comprising:
an obtainment unit configured to input text data, the text data being divided into a plurality of part data each including a linguistic meaning;
a selection unit configured to select at least one part data from the plurality of part data according to a predetermined condition;
a size change unit configured to reduce a display size of the text data relative to a display area by editing the at least one part data; and
an output device having the display area configured to display the text data in which the at least one part data is edited.

2. The apparatus according to claim 1,
wherein said obtainment unit divides the text data into the plurality of part data.

3. The apparatus according to claim 1,
wherein said obtainment unit divides the text data by a part of speech, the part of speech corresponding to each part data.

4. The apparatus according to claim 3,
further comprising an importance degree table configured to correspondingly store a part of speech and an importance degree, and
wherein said selection unit assigns the importance degree to each part data corresponding to the part of speech stored in said importance degree table.

5. The apparatus according to claim 4,
wherein said obtainment unit inputs control data including a set display speed and a set display time in the case of scroll-displaying the text data on the display area.

6. The apparatus according to claim 5,
wherein said size change unit calculates a display area size based on an actual size of the display area, the set display speed and the set display time, calculates a total display size of the text data based on the number of characters included in the text data, and compares the display area size with the total display size of the text data.

7. The apparatus according to claim 6,
wherein, when the display area size is smaller than the total display size of the text data, said size change unit calculates a reduction ratio of display width of each part of speech based on the importance degree, the set display speed, the set display time, and a standard display time of the text data.

8. The apparatus according to claim 7,
wherein said size change unit calculates a part display time of each part data based on a standard display time of the part data and the reduction ratio of display width of the part of speech corresponding to the part data.

9. The apparatus according to claim 8,
wherein said size change unit reduces a display size of the part data based on a reduction ratio in inverse proportion to the part display time of the part data.

10. The apparatus according to claim 1,
wherein said obtainment unit inputs speech data, and generates the text data by converting the speech data.

11. The apparatus according to claim 8,
further comprising a memory unit configured to store display control data correspondingly including each part data, the part display time and the part of speech.

12. The apparatus according to claim 11,
wherein said obtainment unit inputs speech data and video data each corresponding to the text data, and
further comprising a replay speed conversion unit configured to reduce a replay time of the speech data and the video data based on the set display speed and the set display time.

13. The apparatus according to claim 12,
wherein said output device replays the speech data and the video data based on the reduced replay time in synchronization with the text data displayed through the display area.

14. The apparatus according to claim 13,
wherein said memory unit correspondingly stores the speech data, the video data, the text data, and the display control data.

15. The apparatus according to claim 6,
wherein said importance degree table correspondingly stores a conjunction and an importance degree,
wherein said selection unit assigns the importance degree to each part data including the conjunction stored in said importance degree table,
wherein said size change unit selects each part data from the plurality of part data in higher order of the importance degree on condition that a sum of the part display time of the selected part data is within the set display time, and
wherein said output device displays the selected part data.

16. The apparatus according to claim 6,
wherein said importance degree table correspondingly stores a pair of words and a probability value which the pair of words are included in documents,
wherein said selection unit assigns the probability value to contiguous two words included in the text data,
wherein said size change unit selects the contiguous two words of which probability value is below a predetermined threshold from all of contiguous two words, and
wherein said output device displays the selected words.

17. The apparatus according to claim 2,
wherein said obtainment unit divides the text data into a plurality of words,
wherein said size change unit alternately selects each word from the plurality of words, and
wherein said output device displays the selected words.

18. The apparatus according to claim 2,
wherein said obtainment unit divides the text data into a plurality of sentences,
wherein said size change unit selects a sentence including a keyword from the plurality of sentences on condition that the number of keywords included in the sentence is above a threshold, and
wherein said output device displays the selected sentences.

19. A method for editing text data, comprising:
inputting text data, the text data being divided into a plurality of part data each including a linguistic meaning;
selecting at least one part data from the plurality of part data according to a predetermined condition;
reducing a display size of the text data relative to a display area by editing the at least one part data; and
displaying the text data in which the at least one part data is edited on the display area.

20. A computer program product, comprising:
a computer readable program code embodied in said product for causing a computer to edit text data, said computer readable program code comprising:
a first program code to input text data, the text data being divided into a plurality of part data each including a linguistic meaning;
a second program code to select at least one part data from the plurality of part data according to a predetermined condition;
a third program code to reduce a display size of the text data relative to a display area by editing the at least one part data; and
a fourth program code to display the text data in which the at least one part data is edited on the display area.
